(19) United States
(12) Patent Application Publication
(10) Pub. No.: US 2025/0257282 A1
(43) Pub. Date: Aug. 14, 2025

(54) VEGETABLE OIL TREATMENT WITH STRONG SPENT ACIDS

(71) Applicant: EXXONMOBIL TECHNOLOGY AND ENGINEERING COMPANY, Spring, TX (US)

(72) Inventors: Mustafa AL-SABAWI, London (CA); Aaron SATTLER, Annandale, NJ (US); John DUSSEAULT, Sarnia (CA); Jason WHITTAKER, The Woodlands, TX (US); Lindsay MITCHELL, Camlachie (CA)

(21) Appl. No.: 19/047,351

(22) Filed: Feb. 6, 2025

Related U.S. Application Data
(60) Provisional application No. 63/551,409, filed on Feb. 8, 2024.

(51) Int. Cl. C11B 3/04

(52) U.S. Cl. CPC C11B 3/04

(57) ABSTRACT

Systems and methods are provided for using inorganic spent acids for treatment of triglyceride-containing feeds to remove phosphorus and/or metals. The spent acid can correspond to an acid that has previously been used in a refinery process and/or another process for treatment of a hydrocarbon-like feed, so that the spent acid contains 0.5 vol % to 10 vol % of organic contaminants. These organic contaminants can correspond to hydrocarbon-like compounds that are formed during a prior acid treatment process. A treated triglyceride-containing product can then be recovered by separation.

### CROSS-REFERENCE TO RELATED APPLICATIONS AND PRIORITY CLAIM

This Non-Provisional Patent application claims priority to U.S. Provisional Patent Application No. 63/551,409, filed Feb. 8, 2024, and titled “Vegetable Oil Treatment With Strong Spent Acids”, the entire contents of which is incorporated herein by reference.

### FIELD OF THE INVENTION

Systems and methods are provided for decontamination of vegetable oil feeds with spent strong acids.

### BACKGROUND OF THE INVENTION

One pathway to forming renewable fuels is conversion of vegetables oils (and/or other substantial sources of triglycerides) into fuel boiling range components. Commercial hydroprocessing units can be readily adapted for deoxygenation of triglyceride-containing feeds to produce distillate/diesel boiling range compounds. However, such triglyceride-containing feeds also contain a variety of contaminants that are less compatible with conventional hydroprocessing methods. Such contaminants can include phosphorus and/or various metals. Unfortunately, such phosphorus and/or metal contaminants can be detrimental for the activity of hydroprocessing catalysts at levels of 50 wppm or higher.

Due to the presence of contaminants, triglyceride-containing feeds can be exposed to a decontamination process prior to hydroprocessing, in order to remove phosphorus and/or metals. One example of a suitable decontamination process is an adsorption process, where the triglyceride-containing feed is exposed to a sorbent bed. The phosphorus and/or metals can be removed from the feed by the sorbent in the sorbent bed. While this is effective, the sorbent bed needs to be periodically regenerated. During regeneration, the sorbent bed environment typically includes a portion of the feed that still needs decontamination. This excess triglyceride-containing feed can be displaced with steam, but the excess triglyceride-containing feed still needs treatment after this. The excess feed could be recycled for passage again through the sorbent after regeneration, but this would reduce the net throughput. It would be desirable to have alternative methods for treating such excess triglyceride-containing feed in order to avoid reduction of net throughput for the primary sorbent bed.

Conventionally, vegetable oils have been treated in the food industry in order to remove color bodies. Such processes involve treating the vegetable oil with a bleaching agent, such as Fuller's earth or another type of clay, in combination with an acid, such as sulfuric acid or phosphoric acid.

More generally, it would be desirable to have systems and methods that could reduce or minimize the costs associated with removing metals and/or phosphorus from triglyceride-containing feeds.

European Patent EP 0077528 describes treatment of vegetable oils with phosphoric acid and a bleaching agent, such as Fuller's earth.

U.S. Pat. No. 1,744,843 describes bleaching of fats or oils by exposing the fats or oils to a bleaching earth (such as Fuller's earth or another clay-like substance) and sulfuric acid while agitating the fats or oils. The weight of the clay-like material corresponds to 1 wt % to 10 wt % of the weight of the fats or oils. The sulfuric acid is 60° Baume (roughly 80-85 wt % sulfuric acid solution), and is used in an amount of 2 wt % to 8 wt %.

U.S. Pat. No. 3,590,059 describes bleaching of vegetable or animal oils with a multi-step process that includes treating the oil with an acid and with a bleaching earth/clay. Although organic acids are preferred, mineral acids are described as an alternative. An example describes treating the oil with an amount of bleaching clay that corresponds to 0.6 wt % of the weight of the oil.

U.S. Pat. No. 3,895,042 describes treatment of inedible fatty materials with a bleaching clay and phosphoric acid. The amount of bleaching clay corresponds to 0.1 wt % to 1.0 wt % of the weight of the fatty materials.

Another type of processing unit that is present in some refineries that make fuels is an acid alkylation unit. In a sulfuric acid alkylation unit, olefins can be reacted with small (typically) four carbon isoparaffins in the presence of sulfuric acid to form more highly branched hydrocarbons. Typically, these more highly branched hydrocarbons are valuable as octane and reid vapor pressure improvers for gasoline, although a portion of the resulting more highly branched hydrocarbons can also be incorporated into the jet or diesel pool. Acid alkylation is a relatively well-established refinery process. Examples of acid alkylation processes are provided, for example, in U.S. Pat. Nos. 2,859,260 and 5,095,168.

### SUMMARY OF THE INVENTION

In some aspects, a method for treating a triglyceride-containing feedstock is provided. The method includes mixing a triglyceride-containing feed with a spent acid to form a mixture, the mixture containing 0.05 vol % to 5.0 vol % of spent acid relative to a volume of the triglyceride-containing feed. The triglyceride-containing feed can contain 20 wppm or more of P, Na, Mg, Ca, Ba, Ti, V, Cr, Mn, Fe, Ni, Cu, Zn, or a combination thereof. The spent acid can contain 50 wt % or more of acid and 0.5 wt % to 10 wt % of organic contaminants. Additionally, the method can include separating the mixture to form at least a treated triglyceride-containing product, the treated triglyceride-containing product having a content of the P, Na, Mg, Ca, Ba, Ti, V, Cr, Mn, Fe, Ni, Cu, Zn, or a combination thereof that is lower than the content of the P, Na, Mg, Ca, Ba, Ti, V, Cr, Mn, Fe, Ni, Cu, Zn, or a combination thereof in the triglyceride-containing feed by 50 wt % or more.

In some aspects, the spent acid can correspond to spent sulfuric acid from an acid alkylation process. Optionally, the treated triglyceride-containing product can be mixed the alkylate product from such an acid alkylation process to form a mixed alkylate product. The mixed alkylate product can then be separated.

In some aspects, the triglyceride-containing feed can contain 0.1 wt % or less of silicates and aluminosilicates, such as layered silicates and/or aluminosilicates that correspond to clays.

In other aspects, a method for integration of acid alkylation with treatment of a bio-derived feedstock is provided. The method includes exposing a mixture of isoparaffin and olefins to sulfuric acid under acid alkylation conditions to form an emulsion effluent. The method further includes separating the emulsion effluent to form a spent acid and an alkylate product. The method further includes mixing at least a portion of the spent acid with a bio-derived triglyceride-containing feed containing at least one of 1.0 wppm or more of phosphorus, 1.0 wppm or more of Na, Mg, Ca, Ba, or a combination thereof, and 1.0 wppm or more of Ti, V, Cr, Mn, Fe, Ni, Cu, Zn, or a combination thereof, the mixing being performed under treatment conditions. The method further includes separating the treated mixture to form a second spent acid product and a treated triglyceride-containing product. The method further includes mixing at least a portion of the alkylate product with the treated triglyceride-containing product to form a mixed alkylate product. Additionally, the method includes separating the mixed alkylate product to form a fraction containing a bio-derived product and one or more fractions having a final boiling point that is lower than a final boiling point of the fraction containing the bio-derived product.

### BRIEF DESCRIPTION OF THE FIGURES

FIG. 1 shows an example of a configuration for integrating acid alkylation with decontamination of a bio-derived feedstock.

FIG. 2 shows an example of a sulfuric acid alkylation configuration.

FIG. 3 shows an example of a process flow for treatment of a triglyceride-containing feed with spent acid.

FIG. 4 shows results from treating various canola oil feeds with fresh acid and spent acid.

FIG. 5 shows results from treating various canola oil feeds with fresh acid and spent acid.

### DETAILED DESCRIPTION OF THE EMBODIMENTS

### Overview

In various aspects, systems and methods are provided for using inorganic spent acids for treatment of triglyceride-containing feeds to remove phosphorus and/or metals. The spent acid can correspond to an acid that has previously been used in a refinery process and/or another process for treatment of a hydrocarbon-like feed, so that the spent acid contains 0.5 wt % to 10 wt % of organic contaminants, or 1.0 wt % to 10 wt %, or 0.5 wt % to 5.0 wt %, or 1.0 wt % to 5.0 wt %. These organic contaminants can correspond to hydrocarbon-like compounds that are formed during a prior acid treatment process. For example, if spent sulfuric acid from an acid alkylation process is used as the spent acid for treatment of the triglyceride-containing feed, the organic contaminants are believed to be conjunct polymers in the structure of an olefinic naphthene with carbon number in the C₁₆ to C₃₂ range. The organic contaminants formed by interaction with sulfuric acid are believed to primarily be hydroxyls, ethers, aldehydes, and ketones.

In various aspects, the treatment of the triglyceride-containing feed with the spent acid can be performed in the substantial absence of clay-like materials, such as bleaching clays. For example, the triglyceride-containing feed can be mixed with the spent acid while being substantially free of added clay-like materials. Without intentional addition of clay-like materials, the mixture of triglyceride-containing feed and spent acid can include 0.01 wt % or less of silicate and/or aluminosilicate materials that have a layered structure, which is defined herein as the mixture being substantially free of clay-like materials. More generally, in some aspects, the mixture of triglyceride-containing feed and spent acid can include 0.01 wt % or less of silicate and aluminosilicate materials.

Additionally or alternately, in various aspects, systems and methods are provided for integrating decontamination treatment of triglyceride-containing feeds, such as vegetable oil, with an acid alkylation unit. The integration can reduce or minimize the amount of equipment that is needed for treatment of small input flows of a triglyceride-containing feed, such as the residual vegetable oil stream formed during regeneration of a sorbent bed that is used for vegetable oil decontamination. Alternatively, the integration could be used to allow a refinery that does not have a process train for handling vegetable oil to add the ability to process smaller quantities of vegetable oil while reducing or minimizing capital investment.

Acid alkylation is an example of a refinery/chemical production process that uses sulfuric acid. Typically, sulfuric acid alkylation corresponds to reacting an isoparaffin, such as isobutane, with an olefin, such as a butene, to form a reaction product corresponding to reaction of one isoparaffin with one olefin. It is noted that additional alkylation reactions can occur under alkylation conditions, so some larger compounds are also formed. Such alkylation is performed in the presence of concentrated sulfuric acid, which acts as a catalyst for the reaction (i.e., is not stoichiometrically consumed during the reaction).

The products from such an acid alkylation reaction include the desired alkylate product and “spent” sulfuric acid. The spent sulfuric acid is somewhat reduced in concentration due to the fact that the spent sulfuric acid will contain 0.5 wt % to 10 wt % of hydrocarbon-like compounds that remain in the sulfuric acid after separating out the alkylate product. For acid alkylation processes, this dilution of the sulfuric acid can reduce reaction yields. As a result, acid alkylation processes typically add fresh acid and withdrawn spent acid from the process environment in order to maintain a target concentration for the sulfuric acid. Due to the presence of the contamination in spent sulfuric acid, conventionally the spent sulfuric acid from an alkylation process is processed to remove the contaminants and/or sent off-site for contaminant removal or other disposal.

Although such spent sulfuric acid would normally be recycled, it has been discovered that the spent sulfuric acid can be used for removal of contaminants from triglyceride-containing feeds. In a conventional process for removing color bodies, such spent sulfuric acid would not be suitable, as the hydrocarbon-like contaminants in the sulfuric acid correspond to additional color bodies that can be transferred into the triglyceride-containing feed. However, when attempting to make fuels and/or other products where hydroprocessing will be performed on the triglyceride-containing feed after contaminant removal, the color bodies are of less concern. First, in some fuel applications, color bodies can be present. Additionally, subsequent hydroprocessing and/or distillation can be used to convert at least some compounds that may act as color bodies. As a result, even though spent acid contains hydrocarbon-like contaminants, it has been discovered that such hydrocarbon-like contaminants are not an issue when using the spent acid for phosphorus and/or metal removal from a triglyceride-containing feed.

It is noted that simply adding a triglyceride-containing feed to an acid alkylation process would not be effective for contaminant removal. For example, the relative concentrations of acid and triglyceride-containing feed during decontamination are not sufficiently similar to the conditions present during acid alkylation. During acid alkylation, the weight of acid is typically comparable to the weight of hydrocarbons in the reaction mixture. This is in contrast to decontamination, where the volume of spent sulfuric acid is on the order of 0.1 vol % to 2.0 vol % of the volume of the triglyceride-containing feed. The conditions for one or both processes would have to be modified far from typical desired conditions in order to attempt to perform both acid alkylation and feed decontamination in a single process vessel. It is further noted that the nature of the processes is not similar with regard to how the sulfuric acid is used. In acid alkylation, the sulfuric acid serves as a catalyst. By contrast, decontamination of a triglyceride-containing feed results in stoichiometric consumption of the sulfuric acid, based on the amount of phosphorus and/or metals in the feed.

Although direct integration of acid alkylation with vegetable oil decontamination would cause a variety of problems, in various aspects, other types of integration can be used. In particular, a vegetable oil (or other triglyceride-containing stream) can be added to the acid alkylation system at a downstream location, after separation of the alkylate product from the spent sulfuric acid. This can allow the vegetable oil to be introduced at a location so that both the alkylation process and the decontamination process can be performed under target conditions, while still allowing the vegetable oil acid treatment process to take advantage of at least a portion of the equipment already used for the acid alkylation process.

In such an integrated process, after reacting the vegetable oil with the spent sulfuric acid, the decontaminated vegetable oil can be separated from the spent sulfuric acid. The decontaminated vegetable oil can then be at least partially neutralized (de-acidified), followed by passing the decontaminated vegetable oil into the separation train for the alkylate product. For example, the at least partially neutralized vegetable oil can be added to the alkylate separator where the naphtha boiling range alkylate is separated from the jet or diesel boiling range alkylate products. Optionally, the at least partially neutralized vegetable oil could be added at an earlier location, such as the debutanizer, if such a configuration would be more convenient. Even for carbon chains that have separated from the glycerol backbone of a triglyceride, the vegetable oil products are substantially higher boiling than either the naphtha alkylate products or the jet/diesel alkylate products. Thus, the vegetable oil products can be readily separated in the alkylate separation train to allow for subsequent hydroprocessing of the decontaminated vegetable oil. Alternatively, at least a portion of the alkylate jet/diesel product can also be hydroprocessed with the decontaminated vegetable oil.

In some alternative configurations, the vegetable oil can be introduced into the acid alkylation system at an earlier location, such as prior to the settling tank for separation of the alkylate product from the sulfuric acid.

More generally, any convenient type of spent acid corresponding to an industrial high strength acid could be used. In addition to sulfuric acid, other potential spent acids include spent hydrochloric acid and spent nitric acid. Still other potential spent acids can include phosphoric acid or citric acid. It is noted, however, that acids such as phosphoric acid and citric acid are not classic “strong” acids that have substantially complete dissociation of the first proton under aqueous conditions. As a result, such acids are less favorable, as a higher quantity of acid will typically be needed in order to achieve the same level of decontamination. Additionally, although spent phosphoric acid could potentially be used, due to the goal of reducing phosphorus content in the resulting decontaminated product, use of phosphoric acid could pose difficulties with recovery of the decontaminated product. The spent acid can be formed based on use in any convenient type of prior process for treatment of a hydrocarbon-like feed, so that the spent acid includes roughly 0.5 wt % to 10 wt % of organic contaminants.

### Feedstocks and Products

In various aspects, processing of a bio-derived feedstock can be integrated with an acid alkylation process. In some aspects, the bio-derived feedstock can correspond to a triglyceride-containing feed, such as a vegetable oil. Any convenient type of vegetable oil can be used, including but not limited to, soybean oil, canola (rapeseed) oil, coconut oil, corn oil, sunflower oil, palm oil, castor oil, jatropha oil, or combinations thereof. In such aspects, the bio-derived feedstock can include 20 wt % or more of triglycerides, or 50 wt % or more, or 70 wt % or more, such as up to 99 wt % or possibly still higher. It is noted that vegetable oils (and/or other oils) in triglyceride-containing feeds can correspond to “fresh” oils that have not been used in a prior commercial process, “used” oils such as used cooking oils, or a combination thereof.

In other aspects, the bio-derived feedstock can contain glycerides, diglycerides, triglycerides, and/or free fatty acids. In such aspects, the bio-derived feedstock can include 20 wt % or more of glycerides, diglycerides, triglycerides, and/or free fatty acids, or 50 wt % or more, or 70 wt % or more, such as up to 99 wt % or possibly still higher. Optionally, in such aspects, the amount of triglycerides in the bio-derived feedstock can be 20 wt % or more of triglycerides, or 50 wt % or more, or 70 wt % or more, such as up to 99 wt % or possibly still higher.

In addition to glycerides, diglycerides, triglycerides, and/or free fatty acids, the bio-derived feedstock can include at least one of phosphorus and metals. In various aspects, a bio-derived feedstock can contain 1.0 wppm or more of phosphorus, or 10 wppm or more, or 25 wppm or more, or 50 wppm or more, or 100 wppm or more, or 500 wppm or more, such as up to 5000 wppm or possibly still higher. By exposing the bio-derived feedstock to an acid treatment, the content of phosphorus in the acid-treated feed can be reduced by 50 wt % or more relative to the content of phosphorus in the bio-derived feedstock, or 70 wt % or more, or 90 wt % or more, such as up to substantially complete removal of phosphorus. Additionally or alternately, the phosphorus content can be reduced to 25 wppm or less, or 20 wppm or less, or 10 wppm or less, or 1.0 wppm or less, such as down to having substantially no phosphorus content (0.1 wppm or less). Phosphorus content in a bio-derived feedstock or an acid-treated feed can be determined using inductively coupled plasma-atomic emission spectroscopy (ICP-AES) according at ASTM D5185.

Additionally or alternately, a bio-derived feedstock can potentially contain Group 1 metals (alkali metals) and/or Group 2 metals (alkaline earth metals) of the current IUPAC periodic table. ASTM D5185 can be used to characterize the content of Na (Group 1) as well as Mg, Ca, and Ba (Group 2). In some aspects, a bio-derived feedstock can contain 1.0 wppm or more of Na, Mg, Ca, Ba, or a combination thereof, or 10 wppm or more, or 25 wppm or more, or 50 wppm or more, or 100 wppm or more, or 500 wppm or more, such as up to 5000 wppm or possibly still higher. By exposing the bio-derived feedstock to an acid treatment, the content of Na, Mg, Ca, Ba, or a combination thereof in the acid-treated feed can be reduced by 50 wt % or more relative to the corresponding content of Na, Mg, Ca, Ba, or a combination thereof in the bio-derived feedstock, or 70 wt % or more, or 90 wt % or more, such as up to substantially complete removal. Additionally or alternately, the content of Na, Mg, Ca, Ba, or a combination thereof can be reduced to 25 wppm or less, or 20 wppm or less, or 10 wppm or less, or 1.0 wppm or less, such as down to having substantially no content of Na, Mg, Ca, Ba, or a combination thereof (0.1 wppm or less).

Further additionally or alternately, in some aspects, a bio-derived feedstock can contain first row transition metals from Groups 4-8 and 10-12. The metals correspond to Ti, V, Cr, Mn, Fe, Ni, Cu, and Zn. In some aspects, a bio-derived feedstock can contain 1.0 wppm or more of Ti, V, Cr, Mn, Fe, Ni, Cu, Zn, or a combination thereof, or 10 wppm or more, or 25 wppm or more, or 50 wppm or more, or 100 wppm or more, or 500 wppm or more, such as up to 5000 wppm or possibly still higher. By exposing the bio-derived feedstock to an acid treatment, the content of Ti, V, Cr, Mn, Fe, Ni, Cu, Zn, or a combination thereof in the acid-treated feed can be reduced by 50 wt % or more relative to the corresponding content of Ti, V, Cr, Mn, Fe, Ni, Cu, Zn, or a combination thereof in the bio-derived feedstock, or 70 wt % or more, or 90 wt % or more, such as up to substantially complete removal of the Ti, V, Cr, Mn, Fe, Ni, Cu, Zn, or a combination thereof. Additionally or alternately, the content of Ti, V, Cr, Mn, Fe, Ni, Cu, Zn, or a combination thereof, can be reduced to 25 wppm or less, or 20 wppm or less, or 10 wppm or less, or 1.0 wppm or less, such as down to having substantially no content of Ti, V, Cr, Mn, Fe, Ni, Cu, Zn, or a combination thereof (0.1 wppm or less). Metals content in a bio-derived feedstock or an acid-treated feed can be determined according to ASTM D5185.

It is noted that the metals tested for in ASTM D5185 are Ag, Al, B, Ba, Ca, Cd, Cr, Cu, Fe, Mg, Mn, Mo, Na, Ni, P, Pb, S, Si, Sn, Ti, V, and Zn. Because sulfur can be routinely handled by typical refinery processing, the sulfur content that may be present in a triglyceride-containing feed may be of less interest. In some aspects, the metals content of a sample can be characterized based on the content of the non-sulfur metals (i.e., the metals other than sulfur) that can be determined according to ASTM D5185. In such aspects, a bio-derived feedstock can contain 1.0 wppm or more of the non-sulfur metals that are tested for in ASTM D5185, or 10 wppm or more, or 25 wppm or more, or 50 wppm or more, or 100 wppm or more, or 500 wppm or more, such as up to 5000 wppm or possibly still higher. By exposing the bio-derived feedstock to an acid treatment, the content of non-sulfur metals tested for in D5185 in the acid-treated feed can be reduced by 50 wt % or more relative to the corresponding content of non-sulfur metals tested for in D5185 in the bio-derived feedstock, or 70 wt % or more, or 90 wt % or more, such as up to substantially complete removal of the non-sulfur metals tested for in ASTM D5185. Additionally or alternately, the content of the non-sulfur metals tested for in ASTM D5185 can be reduced to 25 wppm or less, or 20 wppm or less, or 10 wppm or less, or 1.0 wppm or less, such as down to having substantially no content of the non-sulfur metals tested for in ASTM D5185.

As an example of a process for forming spent acid, an acid alkylation process is described herein. For the acid alkylation process, an olefinic feed and an isoparaffinic feed can be used as input feedstocks for the process. The olefinic feed can correspond to a feed that contains 50 wt % or more, relative to the weight of hydrocarbons in the feed, of C₂ to C₆ olefins. An example of such an olefin is 1-butene. The isoparaffinic feed can correspond to a feed that contains 50 wt % or more, relative to the weight of hydrocarbons in the feed, of C₄ to C₆ isoparaffins, such as isobutane.

The acid alkylation process forms an alkylate product stream or effluent. In some aspects, the alkylate product stream can be separated to form a light alkylate product and a heavier product, such as a heavy alkylate product or a combined heavy alkylate and decontaminated vegetable oil product. For example, the alkylate product stream from acid alkylation can be separated to form a light alkylate with a T90 distillation point of 170° C. or less, or 150° C. or less, or 140° C. or less, such as down to a T90 distillation point of 100° C. or possibly still lower. A heavy alkylate can also be formed that has a T10 distillation point of 140° C. or higher, or 150° C. or higher, and a T90 distillation point of 210° C. or less, or 200° C. or less, or 190° C. or less, or 180° C. or less. In aspects where a portion of decontaminated vegetable oil is combined with the alkylate product stream, the initial separation to form a light alkylate product can result in the heavier product having a higher T90 distillation point, due to the presence of the decontaminated vegetable oil product. In such aspects, the heavy fraction can optionally be further separated to form a heavy alkylate product and a higher boiling fraction that contains components from the decontaminated vegetable oil. Such a higher boiling fraction can have a T10 distillation point of 180° C. or higher, or 190° C. or higher, or 200° C. or higher, or 210° C. or higher. Because such a higher boiling fraction can potentially contain triglycerides, the T90 distillation point of such a higher boiling fraction can be relatively high, and possibly up to 550° C. or even higher. Fractional weight distillation points can be determined according to ASTM D2887.

In addition to forming the light alkylate and heavy alkylate products, one or more lighter fractions can potentially also be separated from the alkylate product. For example, prior to the separation for forming the light alkylate product, one or more C₆₋ streams can be separated from the alkylate product. These C₆₋ streams can include unreacted isoparaffins. Such C₆₋ streams can also include small alkanes. As an example, in an aspect where isobutane and butenes are used as the isoparaffins and olefins, a first separation can be used to separate isobutane (and other lower boiling compounds) from the alkylate product stream, thus forming a C₄₋ isoparaffin fraction. Another separation can separate butane from the alkylate product stream, resulting in a C₄₋ alkane n-paraffin fraction. This also corresponds to forming a debutanized alkylate product stream.

### Conditions for Treatment of Bio-Derived Feed and Acid Alkylation

The conditions for acid alkylation can correspond to any convenient conditions that are suitable for acid alkylation, including conventional conditions. Examples of suitable conditions for acid alkylation can include a volume ratio of isoparaffins to olefins (excluding refrigerant) of between 3.0 and 10; a pressure of 1.0 kPa-g to 450 kPa-g; and a temperature of 2° C. to 13° C. The sulfuric acid can correspond to sulfuric acid with a concentration of 86 wt % or more, or 90 wt % or more, such as up to being substantially only composed of sulfuric acid. The volume ratio of sulfuric acid to hydrocarbons can be roughly 1.0 to 2.0.

In various aspects, spent acid from the acid alkylation process can be used for treatment of a bio-derived feedstock (i.e., a triglyceride-containing feed). During acid treatment, the bio-derived feedstock is mixed with the spent acid, and the spent acid is maintained in contact with the bio-derived feed in the mixture for a period of time. The triglyceride-containing feed can be contacted with the spent acid under any convenient conditions, such as a temperature between 5° C. and 95° C. A pressure near 100 kPa-a can be used, but any other convenient pressure can also be suitable. The contact time prior to starting a separation process can range from 1.0 minute to 120 minutes, or 10 minutes to 120 minutes, or 30 minutes to 60 minutes. The spent acid and bio-derived feedstock can be mixed initially, for at least a portion of the contact time, or throughout the contact time. After the contact time, the mixture of spent acid and treated bio-derived feedstock can be separated using a convenient method, such as by centrifugation or settling.

In some aspects, the bio-derived feedstock can be contacted with the spent acid under conditions that are milder than the conditions used during acid alkylation due to the lower concentration of sulfuric acid. For example, the relative amount of acid is substantially lower, so that the spent acid corresponds to roughly 0.05 vol % to 5.0 vol % of the volume of the triglyceride-containing feed, or 0.05 vol % to 3.0 vol %, or 0.1 vol % to 5.0 vol %, or 0.1 vol % to 3.0 vol %, or 1.0 vol % to 5.0 vol %. It is noted that this is based on use of a relatively concentrated spent acid, where the spent acid contains 50 wt % or more of acid relative to the total weight of the spent acid, or 60 wt % or more, or 70 wt % or more, or 80 wt % or more, or 90 wt % or more, such as up to 96 wt %. For example, the sulfuric acid concentration for the spent acid can be 50 wt % to 90 wt %, or 50 wt % to 80 wt %, or 50 wt % to 70 wt %. Depending on the aspect, the sulfuric acid content of the spent acid can be lower than the sulfuric acid concentration of the fresh acid added to the acid alkylation process by 5.0 wt % or more. The amount of spent acid added to the triglyceride-containing feed can be increased if the spent acid contains a higher percentage of water. Optionally, the spent acid and triglyceride-containing feed can be mixed during the contacting of the spent acid with the feed.

After contacting the triglyceride-containing feed with the spent acid, the resulting mixture can be separated by centrifugation, settling, or another convenient method. For example, when using settling, the resulting mixture will separate into roughly two layers. One layer corresponds to a “clean” phase corresponding to roughly 90 vol % to 99 vol % of the organic compounds from the feed, such as roughly 95 vol %. The other layer corresponds to a “dirty” phase that includes the aqueous acid, roughly 0.5 vol % to 10 vol % of the organic compounds from the feed (such as roughly 5.0 vol %), and the substantial majority of the metals and phosphorus originally present in the feed. It is noted that most of the metals and phosphorus may be present in a “rag layer” in the dirty phase at the interface with the clean phase. The clean phase can be recovered as a triglyceride-containing product. The triglyceride-containing product can have a phosphorus and/or metals content of 25 wppm or less, or 20 wppm or less, or 10 wppm or less, such as down to 1.0 wppm or possibly still lower.

### Configuration Examples

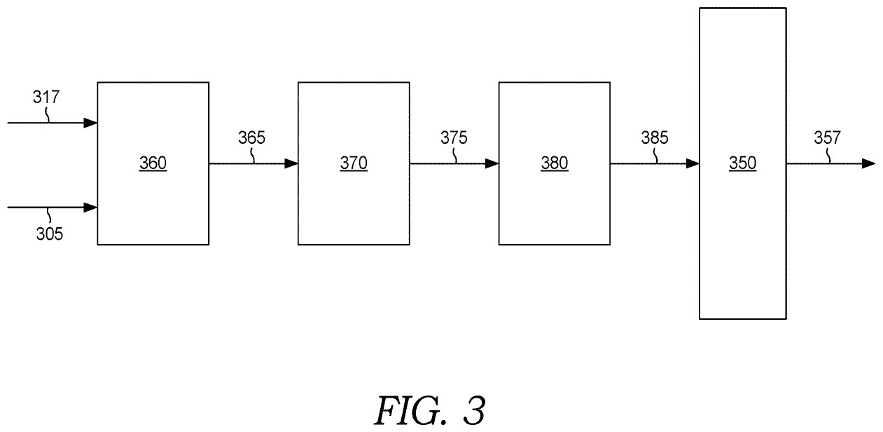

FIG. 3 shows a general example of a configuration for treating a triglyceride-containing feed 305 with a spent acid 317 to produce a triglyceride-containing product 357 with a reduced or minimized content of phosphorus and/or metals. In FIG. 3, feed 305 is mixed with spent acid 317 in mixing stage 360. This results in a mixture 365 of feed and spent acid. The mixture 365 is passed into a separator 370, such as a centrifuge or a settler, to separate a treated triglyceride-containing product 375 from a remaining portion (not shown) of the mixture. The triglyceride-containing product 375 can optionally be treated in an acid removal stage 380 to reduce or minimize the acidity of the product. The optionally reduced acidity product 385 can then be optionally separated 350 to separate out any lower boiling hydrocarbons formed during exposure to the spent acid. This results in a separated product 355, which can then be further processed, such as by hydroprocessing.

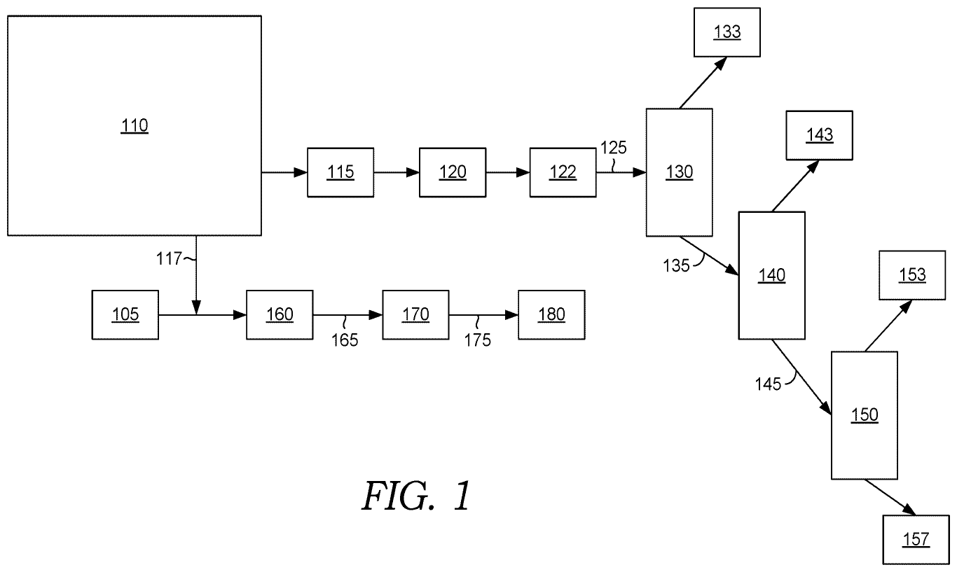

FIG. 1 shows an example of a configuration for integrating a sulfuric acid alkylation process with a process for treatment of vegetable oil. In FIG. 1, acid alkylation process 110 includes both the acid alkylation reactor and the settler that is typically used for separating the hydrocarbon product 115 from the spent acid 117.

As shown in FIG. 1, the hydrocarbon product 115 is passed through a series of separators. In the example shown in FIG. 1, the series of separators include a caustic wash 120 and/or a water wash 122 for at least partially neutralizing and/or removing remaining acid to form a washed stream 125. The series of separators further include a first separation stage 130 for separating at least a portion of unreacted isobutane 133 from the washed stream 125. This forms a de-isobutanized stream 135. The de-isobutanized stream 135 is then passed through a second separation stage 140 for separating out at least a portion of any butane 143 present in de-isobutanized stream 135. This forms a debutanized stream 145. The debutanized stream 145 is then passed into a splitter 150 that separates the light alkylate 153 (naphtha boiling range components) from the heavy alkylate 157 (distillate boiling range components).

Conventionally, spent acid 117 would be recycled and/or otherwise processed to allow for further use. However, in the example configuration shown in FIG. 1, a biofeed 105 is mixed 160 with a portion of or all of the spent acid 117. Any convenient type of mixer can be used as mixer 160, such as a static mixer. The biofeed 105 can correspond to a bio-derived feed, such as a feed that contains triglycerides, that also contains metals and/or phosphorus in amounts above a target level. This produces a mixture 165 of spent acid and feed. The mixture 165 of spent acid and feed is then separated in separation stage 170, such as by settling. This allows for recovery of a treated feed stream 175 that contains 90 wt % or more of the treated feed from mixture 165, or 95 wt % or more, such as up to recovering substantially all of the treated feed. The spent acid that is separated 177 from the treated feed stream 175 can then be further processed to allow for recycle and/or use in other processes and/or processed to remove the contaminants and/or sent off-site for contaminant removal or other disposal. The treated feed stream 175 can then be passed into a neutralization stage 180 to form a pH-adjusted product 185.

The resulting pH-adjusted product 185 can be combined with the alkylate products at any convenient location. In the example shown in FIG. 1, the pH-adjusted product 185 is passed into second separation stage 140, which corresponds to a debutanizer in the configuration shown in FIG. 1. This can allow for removal of any light ends formed during the acid treatment of the bio-derived feed. The pH-adjusted product 185 forms part of debutanized product 145, which is then passed into splitter 150. The pH-adjusted product is primarily composed of components that will become part of heavy distillate product 157. Optionally, heavy distillate product 157 can be further separated (not shown) to separate the alkylate portion of heavy distillate product 157 from the pH-adjusted product portion of heavy distillate product 157. This allows for hydrotreatment of just the pH-adjusted product portion of heavy distillate product 157. Another option can be to hydrotreat all of heavy distillate product 157. Hydrotreatment (not shown) can be used to de-oxygenate the bio-derived components from pH-adjusted product 185 that became part of heavy distillate product 157.

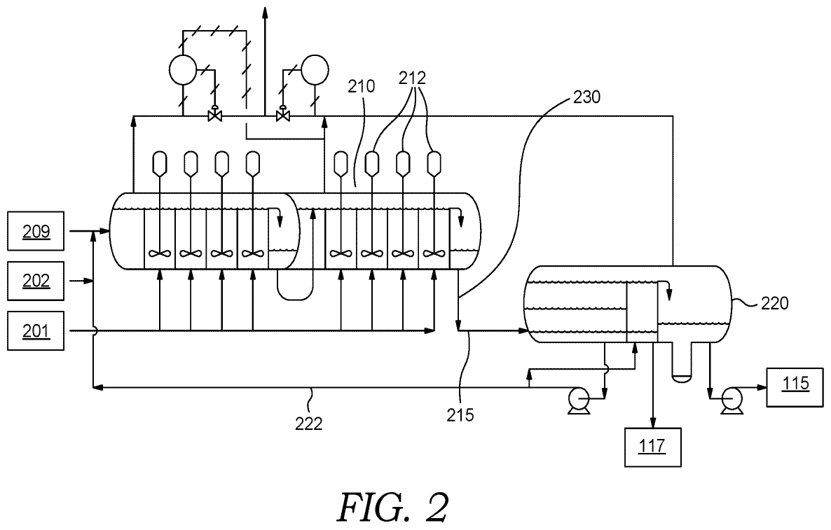

FIG. 2 shows an example of an acid alkylation stage, such as acid alkylation stage 110 from FIG. 1. The example shown in FIG. 2 also shows an alternative location for addition of a bio-derived feed for integration of acid alkylation with acid treatment of a bio-derived feed.

In FIG. 2, the acid alkylation process occurs in alkylation vessel 210. Alkylation vessel 210 includes mixers 212 for mixing the interior of the alkylation environment. In the example shown in FIG. 2, the inputs to the alkylation vessel 210 include a refrigerant stream 209, a make-up acid stream 202, a recycled acid stream 222, and a reactant stream 201 which includes the olefins (such as butene) plus isoparaffins (such as isobutane) used for the alkylation reaction. It is noted that reactant stream 201 can include recycled isoparaffins. The alkylation vessel produces an alkylation effluent 215 that corresponds to an emulsion of spent acid and alkylation products. The alkylation effluent 215 is passed into settling tank 220 to separate spent acid 117 from alkylation products 115.

FIG. 2 also shows an alternative location 230 for addition of a bio-derived feed. In the example shown in FIG. 2, a bio-derived feed 205 can be added to alkylation effluent 215 prior to passing the alkylation effluent 215 into the settling tank 220.

### Treatment Examples

In a first set of runs, both fresh and spent sulfuric acid was used for decontamination of various canola oil samples. The fresh sulfuric acid was representative of a sulfuric acid that would be used for acid alkylation, with a sulfuric acid content of greater than 90 wt %. The spent sulfuric acid was generated from an acid alkylation process. The spent sulfuric acid had a sulfuric acid content of 93 wt % and an organic (hydrocarbon-like compound) content of 2.1 wt %. The fresh or spent sulfuric acid was mixed with the canola oil in a volume ratio of 1:100 at roughly 40° C. and roughly ambient pressure (˜100 kPa-a). The canola oil and acid remained in contact in the mixture for roughly 30 minutes, followed by centrifugation to separate the treated canola oil from the aqueous acid phase and the “dirty” metal-containing hydrocarbon phase.

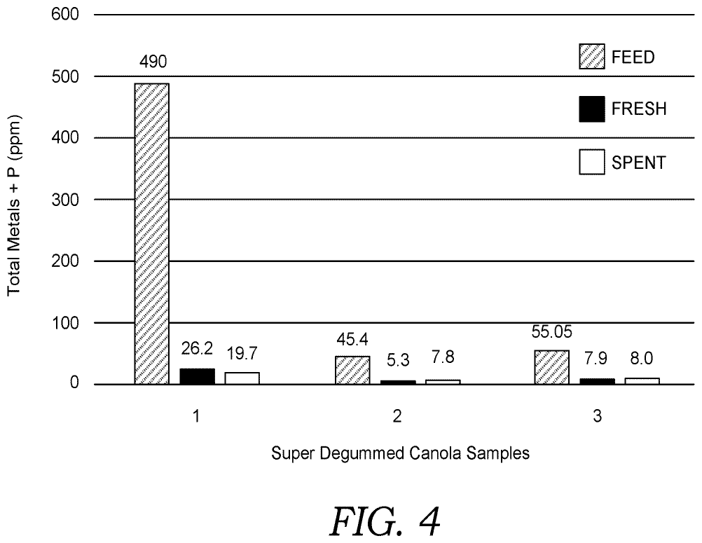

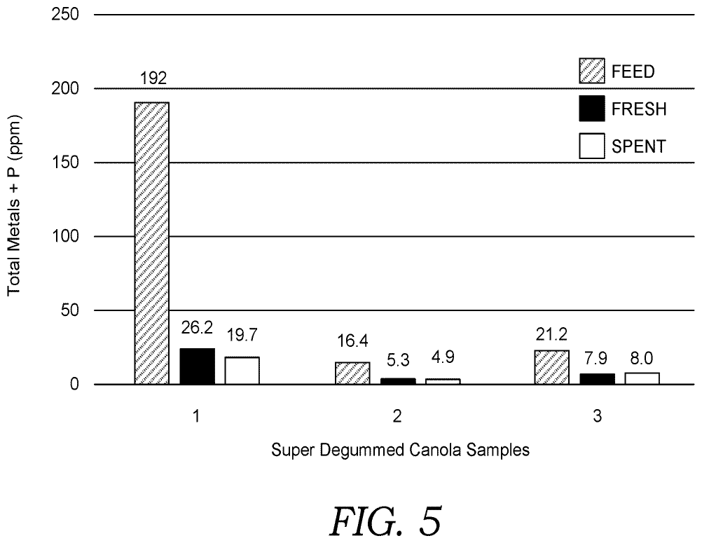

FIG. 4 and FIG. 5 show results from the decontamination process. FIG. 4 shows the reduction in combined phosphorus plus metals after treatment of three different canola oils with either fresh or spent acid. As shown in FIG. 4, the first canola oil feed initially had a combined phosphorus plus metals content of 490 wppm. This corresponds to the total for the 22 elements tested for in ASTM D5185. After treatment with fresh acid, the combined phosphorus and metals content was reduced to 26.2 wppm, while treatment with spent acid reduced the combined phosphorus and metals content to 19.7 wppm. This shows that using either fresh acid or spent acid resulted in substantially similar removal of phosphorus and metals. The second and third canola oil samples had lower initial contents of phosphorus and metals, with initial contents of either 45.2 wppm or 55.1 wppm. As shown in FIG. 4, the removal of combined metals and phosphorus was again substantially similar when using either the fresh acid or the spent acid.

FIG. 5 shows data from the same treatments of canola oil, but focuses on just the phosphorus contents. As shown in FIG. 5, the level of phosphorus removal is substantially similar using either fresh acid or spent acid. Thus, based on FIGS. 4 and 5, there does not appear to be any substantial difference for either phosphorus removal or metals removal when using fresh acid vesus spent acid.

Additional decontamination processes were performed on canola oil samples by first performing centrifugation at 3000 rpm for 1.0-2.0 hours at roughly 20° C. (ambient temperature), followed by washing with spent acid. For these processes, 100 ml of canola oil was initially separated using a centrifuge. This resulted in roughly 95 ml of centrifuged canola oil with a reduced metals and phosphorus content. The centrifuged canola oil was then mixed with 1 ml of spent sulfuric acid for a contact time, and then separated to recover a treated canola oil product. Due to the higher density of the phosphorus-containing and/or metal-containing species in a vegetable oil feed, centrifugation can be used to remove at least a portion of the contaminants from a sample. The data in Table 1 and Table 2 shows that spent acid can be used to further reduce the phosphorus and/or metals content of such feeds that have already had some metals removal by another process.

In Table 1, the canola oil sample had an initial combined metals and phosphorus content of 1310 wppm. The centrifugation step reduced the combined metals and phosphorus content for the metals shown in Table 1 to 28.2 wppm. Spent acid treatment was then able to further reduce the combined metals and phosphorus content to less than 5.0 wppm.

TABLE 1
Centrifugation and Spent Acid Wash of High Metals Canola Oil

| | Canola Oil | After | After Spent |
|---|---|---|---|
| | Feed 1 | Centrifugation | Acid Wash |
| amount acid (ml) | | | 1 |
| calcium | 128 | 5.7 | <5.0 |
| iron | 4.8 | <1.0 | <1.0 |
| magnesium | 61.3 | <5.0 | <5.0 |
| potassium | 70 | <5.0 | <5.0 |
| phosphorus | 486 | 10.5 | 2.9 |
| sodium | 560 | 12 | <5.0 |
| Total metals | 1310 | 28.2 | 2.9 |
| (ppm) | | | |

Table 2 shows that similar results were achieved using a canola oil with a lower initial metals and phosphorus content.

TABLE 2
Centrifugation and Spent Acid Wash of Medium Metals Canola Oil

| | Canola Oil | After | After Spent |
|---|---|---|---|
| | Feed 2 | Centrifugation | Acid Wash |
| amount acid (ml) | | | 1 |
| calcium | 46.7 | 5.7 | <5.0 |
| iron | <1.0 | <1.0 | <1.0 |
| magnesium | 22.9 | <5.0 | <5.0 |
| potassium | 28 | <5.0 | <5.0 |
| phosphorus | 192 | 10.5 | 2.9 |
| sodium | 200 | 12 | <5.0 |
| Total metals | 489.6 | 24.9 | 3.9 |
| (ppm) | | | |

### Example of Integration

As an example, the acid treatment of vegetable oil can be the result of integration of an acid alkylation process with an adsorption process for removing contaminants from a vegetable oil feed. In this type of example, the bio-derived feed that is combined with the spent sulfuric acid is formed from a primary process for adsorption of contaminants from a vegetable oil feed. In the primary process for adsorption of contaminants, a vegetable oil feed is exposed to an adsorbent bed for adsorption of phosphorus and/or metals. At some point, the sorbent becomes sufficiently loaded with contaminants and regeneration is needed. At that point, any vegetable oil still remaining in the volume of the adsorbent bed can be removed using a steam purge. The purged vegetable oil can then be decanted to remove water that is mixed with the vegetable oil. After decanting, the resulting purged vegetable oil can be used as the bio-derived feed.

As an example, a vegetable oil feed can be passed over an adsorption bed to remove most of the metals and phosphorus. Some amount of vegetable oil is left in the adsorption bed at the end of the sorption step. For a 20 kilobarrel per day vegetable oil stream, it is estimated that ˜0.4 kilobarrels per day are left in the bed at the end of sorption steps. This remaining vegetable oil can be displaced with steam, such as in a decanting stage. After removal of the steam condensate (such as by decantation), the stripped vegetable oil can be combined with the spent acid stream coming from the alkylation reactor. The spent acid removes metals and phosphorus from the vegetable oil. The spent acid can then be separated from the treated, stripped vegetable oil. The treated, stripped vegetable oil can then be added to the separation train for the acid alkylation process.

### Additional Embodiments

Embodiment 1. A method for treating a triglyceride-containing feedstock, comprising: mixing a triglyceride-containing feed with a spent acid to form a mixture, the mixture comprising 0.05 vol % to 5.0 vol % of spent acid relative to a volume of the triglyceride-containing feed, the triglyceride-containing feed comprising 20 wppm or more of P, Na, Mg, Ca, Ba, Ti, V, Cr, Mn, Fe, Ni, Cu, Zn, or a combination thereof, the spent acid comprising 50 wt % or more of acid and 0.5 wt % to 10 wt % of organic contaminants; and separating the mixture to form at least a treated triglyceride-containing product, the treated triglyceride-containing product having a content of the P, Na, Mg, Ca, Ba, Ti, V, Cr, Mn, Fe, Ni, Cu, Zn, or a combination thereof that is lower than the content of the P, Na, Mg, Ca, Ba, Ti, V, Cr, Mn, Fe, Ni, Cu, Zn, or a combination thereof in the triglyceride-containing feed by 50 wt % or more.

Embodiment 2. A method for integration of acid alkylation with treatment of a bio-derived feedstock, comprising: exposing a mixture of isoparaffin and olefins to sulfuric acid under acid alkylation conditions to form an emulsion effluent; separating the emulsion effluent to form a spent acid and an alkylate product; mixing at least a portion of the spent acid with a bio-derived triglyceride-containing feed comprising at least one of 1.0 wppm or more of phosphorus, 1.0 wppm or more of Na, Mg, Ca, Ba, or a combination thereof, and 1.0 wppm or more of Ti, V, Cr, Mn, Fe, Ni, Cu, Zn, or a combination thereof, the mixing being performed under treatment conditions; separating the treated mixture to form a second spent acid product and a treated triglyceride-containing product; mixing at least a portion of the alkylate product with the treated triglyceride-containing product to form a mixed alkylate product; and separating the mixed alkylate product to form a fraction comprising a bio-derived product and one or more fractions having a final boiling point that is lower than a final boiling point of the fraction comprising the bio-derived product.

Embodiment 3. The method of any of the above embodiments, wherein the mixture comprises 0.1 wt % or less of silicates and aluminosilicates having a layered structure, or wherein the mixture comprises 0.1 wt % or less of silicates and aluminosilicates.

Embodiment 4. The method of any of the above embodiments, wherein the triglyceride-containing feed comprises 25 wppm or more of phosphorus, the treated triglyceride-containing product optionally comprising 20 wppm or less of phosphorus.

Embodiment 5. The method of any of the above embodiments, wherein the triglyceride-containing feed comprises 25 wppm or more of Na, Mg, Ca, Ba, or a combination thereof, the treated triglyceride-containing product optionally comprising 20 wppm or less of Na, Mg, Ca, Ba, or a combination thereof.

Embodiment 6. The method of any of the above embodiments, wherein the triglyceride-containing feed comprises 25 wppm or more of Ti, V, Cr, Mn, Fe, Ni, Cu, Zn, or a combination thereof, the treated triglyceride-containing product optionally comprising 20 wppm or less of the Ti, V, Cr, Mn, Fe, Ni, Cu, Zn, or a combination thereof.

Embodiment 7. The method of any of the above embodiments, wherein the triglyceride-containing feed comprises 50 wppm or more of Ag, Al, B, Ba, Ca, Cd, Cr, Cu, Fe, Mg, Mn, Mo, Na, Ni, P, Pb, Si, Sn, Ti, V, and Zn, and wherein the treated triglyceride-containing product comprises 25 wppm or less of the Ag, Al, B, Ba, Ca, Cd, Cr, Cu, Fe, Mg, Mn, Mo, Na, Ni, P, Pb, Si, Sn, Ti, V, and Zn.

Embodiment 8. The method of any of Embodiments 1 or 3-7, wherein the spent acid comprises spent sulfuric acid, spent nitric acid, spent hydrochloric acid, or a combination thereof.

Embodiment 9. The method of any of Embodiments 1 or 3-7, wherein the spent acid comprises spent sulfuric acid, spent nitric acid, spent hydrochloric acid, spent phosphoric acid, spent citric acid, or a combination thereof.

Embodiment 10. The method of any of the above embodiments, wherein the spent acid is contacted with the triglyceride-containing feed for a contacting time in the mixture prior to the separating, the mixture optionally being mixed during the contacting time.

Embodiment 11. The method of any of the above embodiments, wherein separating the mixture comprises settling, centrifugation, or a combination thereof.

Embodiment 12. The method of any of the above embodiments, a) wherein the triglyceride-containing feed comprises 50 wt % or more of glycerides, diglycerides, triglycerides, free fatty acids, or a combination thereof; b) wherein the triglyceride-containing feed comprises 50 wt % or more of triglycerides; or a combination of a) and b).

Embodiment 13. The method of any of the above embodiments, wherein the spent acid has a sulfuric acid concentration of 90 wt % or less, or 80 wt % or less.

Embodiment 14. The method of any of the above claims, wherein at least a portion of the spent acid comprises spent sulfuric acid from an acid alkylation process.

Embodiment 15. The method of any of the above embodiments, further comprising: passing at least a portion of the treated triglyceride-containing product into the separation system of an acid alkylation system to form a combined product comprising the at least a portion of the treated triglyceride-containing product and an alkylate product; and separating the combined product to form at least a lower boiling fraction and a higher boiling fraction, the higher boiling fraction comprising 50 vol % or more of the triglyceride-containing product.

Additional Embodiment A. The method of any of Embodiments 1 or 3 to 14, wherein separating the mixture further comprises forming a second spent acid product, the method further comprising: exposing a mixture of isoparaffin and olefins to sulfuric acid under acid alkylation conditions to form an emulsion effluent; separating the emulsion effluent to form at least the spent acid and an alkylate product; after separating the mixture, mixing at least a portion of the alkylate product with the treated bio-derived fraction to form a mixed alkylate product; and separating the mixed alkylate product to form a fraction comprising a bio-derived product and one or more fractions having a final boiling point that is lower than a final boiling point of the bio-derived product.

Additional Embodiment B. The method of Additional Embodiment A, wherein mixing at least a portion of the alkylate product with the treated bio-derived fraction comprises: separating at least one C₆₋ stream from the alkylate product to form a debutanized alkylate product; and mixing at least a portion of the debutanized alkylate product with the treated bio-derived fraction to form the mixed alkylate product.

Additional Embodiment C. The method of Additional Embodiment A or B, further comprising increasing the pH of the treated bio-derived fraction prior to mixing the treated bio-derived fraction with the at least a portion of the alkylate product.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

What is claimed is:

1. A method for treating a triglyceride-containing feedstock, comprising:
mixing a triglyceride-containing feed with a spent acid to form a mixture, the mixture comprising 0.05 vol % to 5.0 vol % of spent acid relative to a volume of the triglyceride-containing feed, the triglyceride-containing feed comprising 20 wppm or more of P, Na, Mg, Ca, Ba, Ti, V, Cr, Mn, Fe, Ni, Cu, Zn, or a combination thereof, the spent acid comprising 50 wt % or more of acid and 0.5 wt % to 10 wt % of organic contaminants; and
separating the mixture to form at least a treated triglyceride-containing product, the treated triglyceride-containing product having a content of the P, Na, Mg, Ca, Ba, Ti, V, Cr, Mn, Fe, Ni, Cu, Zn, or a combination thereof, that is lower than the content of the P, Na, Mg, Ca, Ba, Ti, V, Cr, Mn, Fe, Ni, Cu, Zn, or a combination thereof in the triglyceride-containing feed by 50 wt % or more.

2. The method of claim 1, wherein the mixture comprises 0.1 wt % or less of silicates and aluminosilicates having a layered structure.

3. The method of claim 1, wherein the mixture comprises 0.1 wt % or less of silicates and aluminosilicates.

4. The method of claim 1, wherein the triglyceride-containing feed comprises 25 wppm or more of phosphorus.

5. The method of claim 4, wherein the treated triglyceride-containing product comprises 20 wppm or less of phosphorus.

6. The method of claim 1, wherein the triglyceride-containing feed comprises 25 wppm or more of Na, Mg, Ca, Ba, or a combination thereof.

7. The method of claim 6, wherein the treated triglyceride-containing product comprises 20 wppm or less of Na, Mg, Ca, Ba, or a combination thereof.

8. The method of claim 1, wherein the triglyceride-containing feed comprises 25 wppm or more of Ti, V, Cr, Mn, Fe, Ni, Cu, Zn, or a combination thereof.

9. The method of claim 8, wherein the treated triglyceride-containing product comprises 20 wppm or less of the Ti, V, Cr, Mn, Fe, Ni, Cu, Zn, or a combination thereof.

10. The method of claim 1, wherein the triglyceride-containing feed comprises 50 wppm or more of Ag, Al, B, Ba, Ca, Cd, Cr, Cu, Fe, Mg, Mn, Mo, Na, Ni, P, Pb, Si, Sn, Ti, V, and Zn, and wherein the treated triglyceride-containing product comprises 25 wppm or less of the Ag, Al, B, Ba, Ca, Cd, Cr, Cu, Fe, Mg, Mn, Mo, Na, Ni, P, Pb, Si, Sn, Ti, V, and Zn.

11. The method of claim 1, wherein the spent acid comprises spent sulfuric acid, spent nitric acid, spent hydrochloric acid, or a combination thereof.

12. The method of claim 1, wherein the spent acid comprises spent sulfuric acid, spent nitric acid, spent hydrochloric acid, spent phosphoric acid, spent citric acid, or a combination thereof.

13. The method of claim 1, wherein the spent acid is contacted with the triglyceride-containing feed for a contacting time in the mixture prior to the separating.

14. The method of claim 13, wherein the mixture is mixed during the contacting time.

15. The method of claim 1, wherein the separating comprises settling, centrifugation, or a combination thereof.

16. The method of claim 1, wherein at least a portion of the spent acid comprises spent sulfuric acid from an acid alkylation process.

17. The method of claim 1, further comprising:
passing at least a portion of the treated triglyceride-containing product into the separation system of an acid alkylation system to form a combined product comprising the at least a portion of the treated triglyceride-containing product and an alkylate product; and
separating the combined product to form at least a lower boiling fraction and a higher boiling fraction, the higher boiling fraction comprising 50 vol % or more of the triglyceride-containing product.

18. The method of claim 1, wherein the triglyceride-containing feed comprises 50 wt % or more of triglycerides.

19. The method of claim 1, wherein the triglyceride-containing feed comprises 50 wt % or more of glycerides, diglycerides, triglycerides, free fatty acids, or a combination thereof.

20. A method for integration of acid alkylation with treatment of a bio-derived feedstock, comprising:
exposing a mixture of isoparaffin and olefins to sulfuric acid under acid alkylation conditions to form an emulsion effluent;
separating the emulsion effluent to form a spent acid and an alkylate product;
mixing at least a portion of the spent acid with a bio-derived triglyceride-containing feed comprising at least one of
1.0 wppm or more of phosphorus,
1.0 wppm or more of Na, Mg, Ca, Ba, or a combination thereof, and
1.0 wppm or more of Ti, V, Cr, Mn, Fe, Ni, Cu, Zn, or a combination thereof, the mixing being performed under treatment conditions;
separating the treated mixture to form a second spent acid product and a treated triglyceride-containing product;
mixing at least a portion of the alkylate product with the treated triglyceride-containing product to form a mixed alkylate product; and
separating the mixed alkylate product to form a fraction comprising a bio-derived product and one or more fractions having a final boiling point that is lower than a final boiling point of the fraction comprising the bio-derived product.

21. The method of claim 20, wherein mixing at least a portion of the alkylate product with the treated triglyceride-containing product comprises:
separating at least one C₆₋ stream from the alkylate product to form a debutanized alkylate product; and
mixing at least a portion of the debutanized alkylate product with the treated triglyceride-containing product to form the mixed alkylate product.

22. The method of claim 20, further comprising increasing the pH of the treated triglyceride-containing product prior to mixing the treated triglyceride-containing product with the at least a portion of the alkylate product.

23. The method of claim 20, wherein the spent acid has a sulfuric acid concentration of 90 wt % or less.

24. The method of claim 20, wherein the spent acid has a sulfuric acid concentration of 80 wt % or less.
